(19) United States
(12) Patent Application Publication
(10) Pub. No.: US 2026/0201103 A1
(43) Pub. Date: Jul. 16, 2026

(54) POLYURETHANE FOAM WITH EO/PO COPOLYMER

(71) Applicant: BASF SE, Ludwigshafen am Rhein (DE)

(72) Inventors: Yue Yang, Canton, MI (US); Theodore M. Smiecinski, Woodhaven, MI (US); Mark Patrick McBride, Ferndale, MI (US); Thomas H. Plegue, Grosse lle, MI (US)

(73) Assignee: BASF SE, Ludwigshafen am Rhein (DE)

(21) Appl. No.: 19/130,685

(22) PCT Filed: Dec. 15, 2023
(86) PCT No.: PCT/US2023/084384

§ 371 Date: May 16, 2025

Related U.S. Application Data
(60) Provisional application No. 63/434,509, filed on Dec. 22, 2022.

(30) Foreign Application Priority Data
Mar. 29, 2023 (EP) 23165001.1

(51) Int. Cl. C08G 18/48; C08G 18/76

(52) U.S. Cl. CPC C08G 18/4816; C08G 18/4841; C08G 18/4845; C08G 18/7621; C08G 2110/0008; C08G 2110/0083

(57) ABSTRACT

A polyurethane (PU) foam prepared from a reaction mixture comprising components: a. at least one isocyanate; b. a polyol composition having at least one EO/PO copolymer (P1) with components ethylene oxide (EO), propylene oxide (PO), and glycerine; c. at least one additive; and d. optionally, at least one chain extender; wherein the at least one EO/PO copolymer (P1) includes i. component of ethylene oxide (EO) from 8.0 wt. % to 40.0 wt. %, ii. component of propylene oxide (PO) from 59.0 wt. % to 91.0 wt. %, and iii. component of glycerine from 0.1 wt. % to 5.0 wt. % of the at least one EO/PO copolymer (P1); wherein the at least one EO/PO copolymer (P1) optionally includes a propylene oxide (PO) capping.

### FIELD OF INVENTION

The present invention relates to a polyurethane (PU) foam, a process of producing the polyurethane foam, an article formed of the polyurethane foam and uses thereof.

### BACKGROUND OF THE INVENTION

Polyurethane (PU) foams are widely used for the physical properties of flexibility, ability to form variety of shapes, molding. However, many PU foams have environmental, health and safety challenges based on the components used in the reaction mixture for forming the PU foams. Replacing the components of the reaction mixture of the PU foam with environmentally safer components is associated with loss of physical properties.

PU foams lose tensile strength, density, elongation, indentation force deflection value on replacement of existing components with safer components. It was, therefore, an object of the present invention to provide for a PU foam such that the PU composition is associated with similar or improved physical properties despite replacement of the components of the reaction mixture of the PU foam.

### SUMMARY OF THE INVENTION

Surprisingly, it has been found that the above identified object is met by providing a polyurethane foam, a process of producing the polyurethane (PU) foam, an article formed of the polyurethane foam, uses thereof. The PU foam includes polyol composition with at least one EO/PO copolymer (P1) having more reactive profile. The at least one EO/PO copolymer (P1) enables use of less tin catalyst (Cat A). less amine catalyst (Am) thereby reducing the VOC value, over all less usage of catalysts and surfactants. The polyurethane foam is also referred to as PU foam herein.

In an aspect, the present invention is directed to a polyol composition, wherein the polyol composition includes at least one EO/PO copolymer (P1) comprising:
a. component of ethylene oxide (EO) from 8.0 wt. % to 40.0 wt. %,
b. component of propylene oxide (PO) from 59.0 wt. % to 91.0 wt. %, and
c. component of glycerine from 0.1 wt. % to 5.0 wt. % of the at least one EO/PO copolymer (P1);
wherein the at least one EO/PO copolymer (P1) optionally includes a propylene oxide (PO) capping.

In another aspect, the present invention is directed to a polyurethane (PU) foam prepared from a reaction mixture comprising components:
a. at least one isocyanate (ISO);
b. a polyol composition having at least one EO/PO copolymer (P1) with components ethylene oxide (EO), propylene oxide (PO). and glycerine;
c. at least one additive; and
d. optionally, at least one chain extender:
wherein the at least one EO/PO copolymer (P1) includes
i. component of ethylene oxide (EO) from 8.0 wt. % to 40.0 wt. %,
ii. component of propylene oxide (PO) from 59.0 wt. % to 91.0 wt. %, and
iii. component of glycerine from 0.1 wt. % to 5.0 wt. % of the at least one EO/PO copolymer (P1);
wherein the at least one EO/PO copolymer (P1) optionally includes a propylene oxide (PO) capping.

In another aspect, the present invention is directed to a process of forming the polyurethane foam, the process comprising the steps:
a. mixing components of the reaction mixture as described herein;
b. optionally heating the reaction mixture;
c. optionally curing the polyurethane foam.

In another aspect, the present invention is directed to an article prepared by the polyurethane foam described herein, or by the process of forming the polyurethane foam as described herein.

In another aspect, the present invention is directed to use of the polyurethane foam as described herein or formed by the process of forming the polyurethane foam as described herein, or an article having the polyurethane foam.

In another aspect, the present invention is directed to a method of preparing articles for automotive. furnishing, bedding industry comprising at least the step of providing a polyurethane foam as described herein.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

The terms “comprising”, “comprises” and “comprised of” as used herein are synonymous with “including”, “includes” or “containing”, “contains”, and are inclusive or open ended and do not exclude additional, non-recited members, elements or method steps. It will be appreciated that the terms “comprising”, “comprises” and “comprised of” as used herein comprise the terms “consisting of”, “consists” and “consists of”.

Furthermore. the terms “first”. “second”. “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds. minutes. hours, days, weeks, months or even years between such steps. unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well, i.e., a range of 1 to 10 implies that both 1 and 10 are included in the range. For the avoidance of doubt, the applicant shall be entitled to any equivalents according to applicable law.

### Polyol Composition

In an aspect, the present invention is directed to a polyol composition, wherein the polyol composition includes at least one EO/PO copolymer (P1) comprising:
a. component of ethylene oxide (EO) from 8.0 wt. % to 40.0 wt. %,
b. component of propylene oxide (PO) from 59.0 wt. % to 91.0 wt. %, and
c. component of glycerine from 0.1 wt. % to 5.0 wt. % of the at least one EO/PO copolymer (P1).

The at least one EO/PO copolymer (P1) is formed of ethylene oxide (EO), propylene oxide (PO) and glycerine.

The at least one EO/PO copolymer (P1) includes higher EO % compared to the prior art polyols used for slab foam application. The higher EO % makes the at least one EO/PO copolymer (P1) more reactive, allowing for reduction of amine catalyst (Am), tin catalyst (Cat A) and surfactant in the urethane reaction.

In an embodiment, the at least one EO/PO copolymer (P1) includes component of ethylene oxide (EO) from 8.0 wt. % to 40.0 wt. % of the at least one EO/PO copolymer (P1). In a preferred embodiment, component of ethylene oxide (EO) from 9.0 wt. % to 40.0 wt. %, or from 10.0 wt. % to 40.0 wt. % of the at least one EO/PO copolymer (P1). In a more preferred embodiment, component of ethylene oxide (EO) from 10.0 wt. % to 38.0 wt. %, or from 10.0 wt. % to 36.0 wt. %, or from 10.0 wt. % to 34.0 wt. %, or from 10.0 wt. % to 32.0 wt. %, or from 10.0 wt. % to 30.0 wt. % of the at least one EO/PO copolymer (P1).

In another preferred embodiment, component of ethylene oxide (EO) from 11.0 wt. % to 30.0 wt. %. or from 12.0 wt. % to 30.0 wt. % of the at least one EO/PO copolymer (P1).

In an embodiment the at least one EO/PO copolymer (P1) includes component of propylene oxide (PO) from 59.0 wt. % to 91.0 wt. % of the at least one EO/PO copolymer (P1). In a preferred embodiment, component of propylene oxide (PO) from 60.0 wt. % to 91.0 wt. %, or from 61.0 wt. % to 91.0 wt. %, from 62.0 wt. % to 91.0 wt. %, or from 63.0 wt. % to 91.0 wt. %, or from 64.0 wt. % to 91.0 wt. %, or from 65.0 wt. % to 91.0 wt. % of the at least one EO/PO copolymer (P1). In another preferred embodiment, component of propylene oxide (PO) from 65.0 wt. % to 90.0 wt. %, or from 65.0 wt. % to 89.0 wt. %, from 65.0 wt. % to 88.0 wt. %, or from 65.0 wt. % to 87.0 wt. % of the at least one EO/PO copolymer (P1).

In a preferred embodiment, component of propylene oxide (PO) from 66.0 wt. % to 86.0 wt. % of the at least one EO/PO copolymer (P1).

In an embodiment, the at least one EO/PO copolymer (P1) includes component of glycerine from 0.1 wt. % to 5.0 wt. % of the at least one EO/PO copolymer (P1). In a preferred embodiment the at least one EO/PO copolymer (P1) includes component of glycerine from 0.2 wt. % to 5.0 wt. %, from 0.3 wt. % to 5.0 wt. %, or from 0.4 wt. % to 5.0 wt. %, or from 0.5 wt. % to 5.0 wt. %, or from 0.6 wt. % to 5.0 wt. %, or from 0.7 wt. % to 5.0 wt. %, from 0.8 wt. % to 5.0 wt. %, or from 0.9 wt. % to 5.0 wt. %, or from 1.0 wt. % to 5.0 wt. % of the at least one EO/PO copolymer (P1). In another preferred embodiment, the at least one EO/PO copolymer (P1) includes component of glycerine from 1.0 wt. % to 4.0 wt. % of the at least one EO/PO copolymer (P1).

In a preferred embodiment, the at least one EO/PO copolymer (P1) includes
i. component of ethylene oxide (EO) from 12.0 wt. % to 30.0 wt. % of the at least one EO/PO copolymer (P1);
ii. component of propylene oxide (PO) from 65.0 wt. % to 87.0 wt. % of the at least one EO/PO copolymer (P1);
iii. component of glycerine from 1.0 wt. % to 5.0 wt. % of the at least one EO/PO copolymer (P1).

In another preferred embodiment, the at least one EO/PO copolymer (P1) includes
i. component of ethylene oxide (EO) from 12.0 wt. % to 30.0 wt. % of the at least one EO/PO copolymer (P1);
ii. component of propylene oxide (PO) from 66.0 wt. % to 86.0 wt. % of the at least one EO/PO copolymer (P1);
iii. component of glycerine from 2.0 wt. % to 4.0 wt. % of the at least one EO/PO copolymer (P1).

In another preferred embodiment, the at least one EO/PO copolymer (P1) includes
i. component of ethylene oxide (EO) from 12.0 wt. % to 27.0 wt. % of the at least one EO/PO copolymer (P1);
ii. component of propylene oxide (PO) from 66.0 wt. % to 80 wt. % of the at least one EO/PO copolymer (P1);
iii. component of glycerine from 2.0 wt. % to 4.0 wt. % of the at least one EO/PO copolymer (P1).

In an embodiment, the at least one EO/PO copolymer (P1) has a molecular weight from 1000 g/mol to 6000 g/mol. In a preferred embodiment, the at least one EO/PO copolymer (P1) has molecular weight from 1500 g/mol to 6000 g/mol, or from 2000 g/mol to 6000 g/mol, from 2500 g/mol to 6000 g/mol. In another preferred embodiment, the at least one EO/PO copolymer (P1) has molecular weight from 2500 g/mol to 5500 g/mol, or from 2500 g/mol to 5000 g/mol, from 2500 g/mol to 4500 g/mol, or from 2500 g/mol to 4000 g/mol, or from 2500 g/mol to 4000 g/mol.

In an embodiment, the at least one EO/PO copolymer (P1) is made by a process selected from continuous process, semi-batch process, as well as continuous addition of starters process.

In a preferred embodiment, the at least one EO/PO copolymer (P1) is a random copolymer. The random copolymer includes various groups randomly distributed along the copolymer chain.

In a more preferred embodiment, the at least one EO/PO copolymer (P1) is modified by “capping” or “end blocking” the terminal hydroxy group or groups (of multi-functional moieties). In an embodiment, the at least one EO/PO copolymer (P1) is a random ethylene oxide (EO)-propylene oxide (PO) polymer with optional propylene oxide (PO) end capping.

In another preferred embodiment, the at least one EO/PO copolymer (P1) is a random ethylene oxide (EO)-propylene oxide (PO) polymer with propylene oxide (PO) end capping.

In an embodiment, the at least one EO/PO copolymer (P1) is a random ethylene oxide (EO)-propylene oxide (PO) polymer with optional propylene oxide (PO) end capping as well as includes alkoxylated glycerol.

In an alternate embodiment, the random copolymer is a random block copolymer.

In another alternate embodiment, the at least one EO/PO copolymer (P1) includes at least one random copolymer and at least one non-random copolymer.

In another alternate embodiment, the at least one EO/PO copolymer (P1) includes at least one non-random copolymer. In a preferred embodiment, the at least one non-random copolymer is a block copolymer. The components (and corresponding wt. %) of ethylene oxide (EO), propylene oxide (PO) and glycerine refer to blocks derived from ethylene oxide (EO), propylene oxide (PO) and glycerine in the block copolymer.

In another alternate embodiment, at least one EO/PO copolymer (P1) including the block copolymer has (EO)n(PO)m(EO)n and (PO)m(EO)n(PO)m structures, wherein n and m are the average number of polymerized ethylene oxide (EO) and propylene oxide (PO) units, respectively, and can be calculated based on the percentage of EO/PO and molecular weight of a structures.

In an embodiment, the at least one EO/PO copolymer (P1) has a OH value (estimated by ASTM D4274-21) from 20 mg KOH/g to 800 mg KOH/g. In a preferred embodiment, the at least one EO/PO copolymer (P1) has a OH value from 20 mg KOH/g to 750 mg KOH/g, from 20 mg KOH/g to 700 mg KOH/g, or from 20 mg KOH/g to 650 mg KOH/g, or from 20 mg KOH/g to 600 mg KOH/g, or from 20 mg KOH/g to 550 mg KOH/g, or from 20 mg KOH/g to 500 mg KOH/g, from 20 mg KOH/g to 450 mg KOH/g, or from 20 mg KOH/g to 400 mg KOH/g, or from 20 mg KOH/g to 350 mg KOH/g, or from 20 mg KOH/g to 300 mg KOH/g, or from 20 mg KOH/g to 250 mg KOH/g. In a more preferred embodiment, the at least one EO/PO copolymer (P1) has a OH value from 25 mg KOH/g to 200 mg KOH/g.

In another embodiment, the at least one EO/PO copolymer (P1) is made using a catalyst. The catalyst includes Double metal cyanide (DMC). Potassium hydroxide (KOH) catalysts, and cobalt zinc catalyst.

In a preferred embodiment, the at least one EO/PO copolymer (P1) is prepared using DMC catalyst.

In another preferred embodiment, the at least one EO/PO copolymer (P1) is prepared using KOH catalyst.

In an embodiment, the at least one EO/PO copolymer (P1) additionally includes a starter. The starter is described herein in regard to the second polyol (P2). The starter includes ethylene glycol (EG), diethylene glycol (DEG), 1,4-butanediol (BUD), neopentyl glycol (NPG), glycerol (GLY), trimethylolpropane (TMP), pentaerythritol (PERY) and sorbitol (SORB), and any biobased starter molecule.

### Polyurethane (PU) Foam

In another aspect, the present invention is directed to a polyurethane (PU) foam prepared from a reaction mixture comprising components:
a. at least one isocyanate (ISO):
b. a polyol composition having at least one EO/PO copolymer (P1) with components ethylene oxide (EO), propylene oxide (PO), and glycerine;
c. at least one additive; and
d. optionally, at least one chain extender;
wherein the at least one EO/PO copolymer (P1) includes
i. component of ethylene oxide (EO) from 8.0 wt. % to 40.0 wt. %,
ii. component of propylene oxide (PO) from 59.0 wt. % to 91.0 wt. %, and
iii. component of glycerine from 0.1 wt. % to 5.0 wt. % of the at least one EO/PO copolymer (P1);
wherein the at least one EO/PO copolymer (P1) optionally includes a propylene oxide (PO) capping.

In an embodiment, the at least one EO/PO copolymer (P1) is as described hereinabove.

In an embodiment, the reaction mixture for the polyurethane foam has the at least one EO/PO copolymer (P1) from 55 wt. % to 75%. In a more preferred embodiment, the reaction mixture has the at least one EO/PO copolymer (P1) from 60 wt. % to 70 wt. %.

In an embodiment, the present invention is directed to the polyurethane foam, wherein the at least one EO/PO copolymer (P1) includes
i. component of ethylene oxide (EO) from 12.0 wt. % to 30.0 wt. % of the at least one EO/PO copolymer (P1);
ii. component of propylene oxide (PO) from 65.0 wt. % to 87.0 wt. % of the at least one EO/PO copolymer (P1);
iii. component of glycerine from 1.0 wt. % to 5.0 wt. % of the at least one EO/PO copolymer (P1).

In another embodiment, the present invention is directed to the polyurethane foam, wherein the at least one EO/PO copolymer (P1) includes
i. component of ethylene oxide (EO) from 12.0 wt. % to 30.0 wt. % of the at least one EO/PO copolymer (P1);
ii. component of propylene oxide (PO) from 66.0 wt. % to 86.0 wt. % of the at least one EO/PO copolymer (P1);
iii. component of glycerine from 2.0 wt. % to 4.0 wt. % of the at least one EO/PO copolymer (P1)

### Second Polyol (P2)

In another embodiment, the present invention is directed to the polyurethane foam, wherein the polyol composition includes at least one second polyol (P2) selected from polyether polyols, polyester polyols, polyetherester polyols, polytetrahydrofuran, polyester diol, or a combination thereof.

The second polyol (P2) is different from the at least one EO/PO copolymer (P1) as described herein.

The second polyol (P2) include polyether polyols, polyester polyols, polyetherester polyols, and a combination thereof.

In another embodiment, the present invention is directed to the polyurethane foam, wherein the at least at least one second polyol (P2) is a polyether polyol, preferably a polyether triol.

In another embodiment, the present invention is directed to the polyurethane foam, wherein the at least at least one second polyol (P2) has a molecular weight in range from 2500 g/mol to 4500 g/mol.

In another embodiment, the present invention is directed to the polyurethane foam, wherein the at least at least one second polyol (P2) has a hydroxyl number in range from 50 mg KOH/g to 60 mg KOH/g calculated by ASTM D4274-21.

In an embodiment, the polyether polyols are obtainable by known methods, for example by anionic polymerization with alkali metal hydroxides, e.g., sodium hydroxide or potassium hydroxide, or alkali metal alkoxides, e.g., sodium methoxide, sodium ethoxide, potassium ethoxide or potassium isopropoxide, as catalysts and by adding at least one amine-containing starter molecule, or by cationic polymerization with Lewis acids, such as antimony pentachloride, boron fluoride etherate and so on, or fuller's earth, as catalysts from one or more alkylene oxides having 2 to 4 carbon atoms in the alkylene moiety.

Starter molecules are generally selected such that their average functionality is preferably in the range of 2.0 to 8.0, and more preferably in the range of 3.0 to 8.0. Optionally, a mixture of suitable starter molecules is used.

Starter molecules for polyether polyols include amine containing and hydroxyl-containing starter molecules. Suitable amine containing starter molecules include, for example, aliphatic and aromatic diamines such as ethylenediamine, propylenediamine, butylenediamine, hexamethylenediamine, phenylenediamines, toluenediamine, diaminodiphenylmethane and isomers thereof.

Other suitable starter molecules further include alkanolamines, e.g., ethanolamine, N-methylethanolamine and N-ethylethanolamine, dialkanolamines, e.g., diethanolamine, N-methyldiethanolamine and N-ethyldiethanolamine, and trialkanolamines, e.g., triethanolamine, and ammonia.

Suitable amine containing starter molecules are selected from ethylenediamine, phenylenediamines, toluenediamine or isomers thereof. In one embodiment, it is ethylenediamine.

Hydroxyl-containing starter molecules are selected from sugars, sugar alcohols, for e.g. glucose, mannitol, sucrose, pentaerythritol, sorbitol; polyhydric phenols, resols, e.g., oligomeric condensation products formed from phenol and formaldehyde, trimethylolpropane, glycerol. glycols such as ethylene glycol, propylene glycol and their condensation products such as polyethylene glycols and polypropylene glycols, e.g., diethylene glycol, triethylene glycol, dipropylene glycol, and water or a combination thereof.

Suitable hydroxyl containing starter molecules are selected from sugar and sugar alcohols such as sucrose, sorbitol, glycerol, pentaerythritol, trimethylolpropane or mixtures thereof. In some embodiments the hydroxyl containing starter molecules are selected from sucrose, glycerol, pentaerythritol or trimethylolpropane.

Suitable alkylene oxides having 2 to 4 carbon atoms are, for example, ethylene oxide, propylene oxide, tetrahydrofuran, 1,2-butlene oxide. 2,3-butylene oxide, and styrene oxide. Alkylene oxides can be used singly, alternatingly in succession or as mixtures. In one embodiment, the alkylene oxides are propylene oxide and/or ethylene oxide. In some embodiments, the alkylene oxides are mixtures of ethylene oxide and propylene oxide that comprise more than 50 wt.-% of propylene oxide.

In another embodiment, the polyester polyols are based on the reaction product of carboxylic acids or anhydrides with hydroxy group containing compounds. Suitable carboxylic acids or anhydrides have preferably from 2 to 20 carbon atoms, or from 4 to 18 carbon atoms, for example succinic acid. glutaric acid, adipic acid. suberic acid. azelaic acid, sebacic acid. decanedicarboxylic acid, maleic acid, fumaric acid, phthalic acid, isophthalic acid, terephthalic acid, oleic acid, phthalic anhydride. Particularly comprising of phthalic acid, isophthalic acid, terephthalic acid, oleic acid and phthalic anhydride or a combination thereof.

Suitable hydroxyl containing compounds are selected from ethanol, ethylene glycol, propylene-1,2-glycol, propylene-1,3-glycol, butyl-ene-1,4-glycol, bu-tylene-2,3-glycol, hexane-1,6-diol, octane-1,8-diol, neopentyl glycol, cyclohexane dimethanol (1,4-bis-hydroxy-methylcyclohexane), 2-methyl-propane-1,3-diol, glycerol, trimethylolpropane, hexane-1,2,6-triol, butane-1,2,4-triol, trimethylolethane, pentaerythritol, quinitol, mannitol, sorbitol, methyl glycoside, diethylene glycol, triethylene glycol, tetraethylene glycol, polyethylene glycol, dipropylene glycol, polypropylene glycol, polyethylenepropylene glycol, dibutylene glycol or polybutylene glycol. In one embodiment, the hydroxyl containing compound is selected from ethylene glycol. propylene-1,2-glycol. propylene-1,3-glycol. butylene-1,4-glycol, butylene-2,3-glycol, hexane-1,6-diol, octane-1,8-diol, neopentyl glycol, cyclohexane dimethanol (1,4-bis-hydroxy-methylcyclohexane), 2-methyl-propane-1,3-diol, glycerol, trimethylolpropane. hexane-1,2,6-triol, butane-1,2,4-triol, trimethylolethane, pentaerythritol, quinitol, mannitol, sorbitol, methyl glycoside or diethylene glycol. In another embodiment, the hydroxyl containing compound is selected from ethylene glycol, propylene-1,2-glycol, pro-pylene-1,3-glycol, butyl-ene-1,4-glycol. butylene-2,3-glycol. hexane-1,6-diol, octane-1,8-diol, neopentyl glycol or diethylene glycol. In still another embodiment, the hydroxyl containing compound is selected from hexane-1,6-diol, neopentyl glycol and diethylene glycol.

Such polyetherester polyols are obtainable as a reaction product of i) at least one hydroxyl-containing starter molecule; ii) of one or more fatty acids, fatty acid monoesters or mixtures thereof; iii) of one or more alkylene oxides having 2 to 4 carbon atoms.

The starter molecules of component i) are generally selected such that the average functionality of component i) is preferably 3.8 to 4.8. or from 4.0 to 4.7, or even from 4.2 to 4.6. Optionally, a mixture of suitable starter molecules is used.

Suitable hydroxyl containing starter molecules of component i) are selected from sugars. sugar alcohols (glucose. mannitol, sucrose, pentaerythritol. sorbitol), polyhydric phenols, resols, e.g., oligomeric condensation products formed from phenol and formaldehyde, trimethylolpropane, glycerol, glycols such as ethylene glycol, propylene glycol and their condensation products such as polyethylene glycols and polypropylene glycols, e.g., diethylene glycol, triethylene glycol, dipropylene glycol. and water or a combination thereof.

In another embodiment, the hydroxyl containing starter molecules of component i) are selected from sugars and sugar alcohols such as sucrose and sorbitol, glycerol, and mixtures of said sugars and/or sugar alcohols with glycerol, water and/or glycols such as, for example, diethylene glycol, dipropylene glycol or combination thereof.

Said fatty acid or fatty acid monoester ii) is selected from polyhydroxy fatty acids, ricinoleic acid. hydroxyl-modified oils. hydroxyl-modified fatty acids and fatty acid esters based in myristoleic acid, palmitoleic acid. oleic acid, stearic acid. palmitic acid, vaccenic acid. petroselic acid, gadoleic acid, erucic acid, nervonic acid, linoleic acid, a- and g-linolenic acid, stearidonic acid, arachidonic acid, timnodonic acid, clupanodonic acid and cervonic acid or a combination thereof. Fatty acids can be used as purely fatty acids. In this regard, preference is given to using fatty acid methyl esters such as, for example, biodiesel or methyl oleate.

Biodiesel is to be understood as meaning fatty acid methyl esters within the meaning of the EN 14214 standard from 2010. Principal constituents of biodiesel, which is generally produced from rapeseed oil, soybean oil or palm oil, are methyl esters of saturated C16 to C18 fatty acids and methyl esters of mono- or pol-yunsaturated C18 fatty acids such as oleic acid, linoleic acid and linolenic acid.

Suitable alkylene oxides iii) having 2 to 4 carbon atoms are, for example, ethylene oxide, propylene oxide, tetrahydrofuran, 1,2-butylene oxide, 2,3-butylene oxide and/or styrene oxide. Alkylene oxides can be used singly, alternatingly in succession or as mixtures.

In another embodiment, the alkylene oxides comprise propylene oxide and ethylene oxide. In another preferred embodiment, the alkylene oxide is a mixture of ethylene oxide and propylene oxide comprising more than 50 wt.-% of propylene oxide. In another embodiment, the alkylene oxide comprises purely propylene oxide.

In another embodiment, the second polyol (P2) has an average functionality in the range of 2.0 to 8.0, the hydroxyl number in the range of 20 mg KOH/g to 800 mg KOH/g and the nominal molecular weight in the range of 200 g/mole to 6000 g/mole.

In another embodiment, the second polyol (P2) used are with the molecular weight distribution from 100 g/mol to 6000 g/mol, or from 200 g/mol to 6000 g/mol, or from 300 g/mol to 6000 g/mol, or from 350 g/mol to 6000 g/mol. In yet another embodiment, the polyol used are with the molecular weight distribution from 350 g/mol to 4500 g/mol, or from 350 g/mol to 4000 g/mol, or from 350 g/mol to 3500 g/mol, or from 350 g/mol to 3000 g/mol, or from 350 g/mol to 3000 g/mol, or from 350 g/mol to 2500 g/mol, or from 350 g/mol to 2450 g/mol, or from 350 g/mol to 2400 g/mol, or from 350 g/mol to 2350 g/mol.

In another preferred embodiment, the at least one second polyol (P2) is polyether polyols, polyester polyols, polyetherester polyols, polytetrahydrofuran, or a combination thereof.

In another preferred the second polyol (P2) is a second polyol composition being a polyol mixture (i) based on the mixture of at least two, preferably separately prepared polyol. By the expression “at least two polyol” it is meant that two different polyols are used, which have different mean molecular weight data.

In another preferred the second polyol composition is a polyol mixture (i) based on the mixture of at least three, preferably separately prepared polyol. By the expression “at least three polyol” it is meant that three different polyols are used, which have different mean molecular weight data.

In another embodiment, the present invention is directed to the polyurethane foam, wherein the polyol composition includes at least two polyols.

### Additives

In an embodiment, the additives in the mixture can be selected from surface-active substances. flame retardant (FR)s, nucleating agents, oxidation stabilizers, lubricants, mold release agents, dyes, pigments, dyes, hindered amine light stabilizers, ultraviolet light absorbers, stabilizers, ultra violet stabilizers, hydroxy stabilizers, plasticizers, epoxy plasticizers, chain regulator, polyethylene wax. antioxidants, defoamers, internal release agents. desiccants. blowing agent (ABA)s and anti-static agents or combinations thereof. Further details regarding additives can be found, for example, in the Kunststoffhandbuch, Volume 7, “Polyurethane” Carl-Hanser-Verlag Munich, 1st edition, 1966 2nd edition, 1983 and 3rd edition, 1993. Suitable amounts of these additives are well known to the person skilled in the art. However, for instance, the additives can be present in amounts up to 20 wt.-% based on the total weight of the polyurethane resin composition.

In another embodiment, the present invention is directed to the polyurethane foam, wherein the at least one additive includes a starter, a silicon, a catalyst, an amine, a flame retardant (FR). a blowing agent (ABA), water, an antioxidant, a mold release agent, a lubricant. a plasticiser, a hydrolysis stabilizer, an anti-blocking agent, a light stabilizer, a cross linker, a catalyst, a rheology additive, a defoamer, a friction reducer, an antistatic agent, a surfactant, and other components, or combination thereof.

### Catalyst:

In an embodiment, the reaction mixture includes a catalyst

Suitable catalysts are well known to the person skilled in the art. Catalysts include tin catalyst (Cat A), tertiary amine and phosphine compounds, metal catalysts such as chelates of various metals, acidic metal salts of strong acids; strong bases, alcoholates and phenolates of various metals, salts of organic acids with a variety of metals, organometallic derivatives of tetravalent tin, trivalent and pentavalent As, Sb and Bi and metal carbonyls of iron and cobalt and mixtures thereof can be used as catalysts in the reaction mixture

In another embodiment, the present invention is directed to the polyurethane foam, wherein the catalyst for the reaction mixture can be selected from tin catalyst (Cat A), an amine catalyst (Am), zinc cobalt catalyst, or combination thereof.

The amine catalyst (Am) include tertiary amines selected from a non-emissive amine catalyst, a triethylamine, tributylamine, N-methylmorpholine, N-ethylmorpholine, N,N, N′,N′-tetramethylethylenediamine, pentamethyl-diethylenetriamine and higher homologues (as described in, for example, DE-A 2,624,527 and 2,624,528), 1,4-diazabicyclo(2.2.2)octane, N-methyl-N′-dimethyl-aminoethylpiperazine, bis-(dimethylaminoalkyl)piperazines, tris(dimethylaminopropyl)hexahydro-1,3,5-triazin, N,N-dimethylbenzylamine, N,N-dimethylcyclohexylamine, N,N-diethyl-benzylamine, bis-(N,N-diethylaminoethyl) adipate, N,N,N′,N′-tetramethyl-1,3-butanediamine, N,N-dimethyl-p-phenylethylamine, 1,2-dimethylimidazole, 2-methylimidazole, monocyclic and bicyclic amines together with bis-(dialkylamino)alkyl ethers, such as 2,2-bis-(dimethylaminoethyl)ether. Triazine compounds, such as, but not limited to, tris(dimethylaminopropyl)hexahydro-1,3,5-triazin can also be used.

Suitable catalysts are likewise known in principle from the prior art. Suitable catalysts are, for example, organic metal compounds selected from the group consisting of tin organyls, titanium organyls, zirconium organyls, hafnium organyls, bismuth organyls, zinc organyls, aluminum organyls and iron organyls, for example tin organyl compounds, preferably tin dialkyls such as dimethyltin or diethyltin, or tin organyl compounds of aliphatic carboxylic acids, preferably tin diacetate, tin dilaurate, dibutyltin diacetate, dibutyltin dilaurate, bismuth compounds such as bismuth alkyl compounds or the like, or iron compounds, preferably iron(Ml) acetylacetonate, or the metal salts of the carboxylic acids, for example tin(II) isooctoate, tin dioctoate, titanic esters or bismuth(III) neodecanoate.

In an embodiment the tin catalyst (Cat A) includes a stannous octoate.

In an embodiment, the reaction mixture has tin catalyst (Cat A) from 0.01 wt. % to 0.3%. In a preferred embodiment, the tin catalyst (Cat A) is from 0.01 wt. % to 0.2 wt. %. In another preferred embodiment, the catalyst is from 0.05 wt. % to 0.2 wt. %.

In a preferred embodiment, the reaction mixture to prepare the PU foam includes a tin catalyst (Cat A) and at least one amine catalyst (Am1 or Am2).

In another preferred embodiment, the reaction mixture to prepare the PU foam includes a tin catalyst (Cat A) and at least two amine catalyst (Am1, Am2).

The catalysts, as described hereinabove, can be present in amounts preferably up to 20 wt.-% based on the total weight of the reaction mixture.

In an embodiment, the reaction mixture has catalyst from 0.1 wt. % to 1.%. In a preferred embodiment, the catalyst is from 0.15 wt. % to 1.0 wt. %. In another preferred embodiment, the catalyst is from 0.15 wt. % to 0.5 wt. %. In a more preferred embodiment, the catalyst is from 0.15 wt. % to 0.35 wt. %.

### Flame Retardant (Fr):

Flame retardant (FR) include silicone, tetrabromobisphenol A, brominated polystyrene oligomers, brominated butadiene-polystyrene copolymers in accordance with WO 2007/058736, tetrabromobisphenol A diallyl ether, and hexabromocyclododecane (HBCD), in particular the industrial products, where these in essence comprise the α-, β-, and γ-isomer with added synergists, such as dicumyl. Preference is given to brominated aromatics, such as tetrabromobisphenol A, and to brominated styrene oligomers. Examples of suitable halogen-free flame retardant (FR)s are expandable graphite, red phosphorus, and phosphorus compounds, such as triphenyl phosphate and 9,10-dihydro-9-oxa-10-phosphaphenanthrene 10-oxide.

Phosphorus compounds include tris(2-chloroisopropyl) phosphate, triethyl phosphate, diethyl ethylphosphonate, cresyl diphenyl phosphate, Exolit OP560, diphenyl 6-(diphenoxyphosphoryloxy)hexahydrofuro[3,2-b]furan-3-yl phosphate, 9,10-dihydro-9-oxa-10-phosphaphenanthrene 10-oxide, and 6H-dibenzo[c,e][1,2]oxaphosphorine 6-oxide.

In an embodiment, the flame retardant (FR) is silicone. The silicone includes alkyl-pendant organosilicone.

The abovementioned flame retardants (FR)s can either be dissolved in the monomers before the polymerization reaction starts or incorporated in the PU by extrusion.

In an embodiment, the reaction mixture includes a flame retardant (FR) from 0.1 wt. % to 2.0 wt. %. In a preferred embodiment, the flame retardant (FR) is from 0.2 wt. % to 2.0 wt. %, or from 0.3 wt. % to 2.0 wt. %, from 0.4 wt. % to 2.0 wt. %. In a more preferred embodiment, the flame retardant (FR) is from 0.4 wt. % to 0.9 wt. % or from 0.4 wt. % to 0.8 wt. %.

### Chain Extender

In an embodiment, the chain extender has a molecular weight of less than 499 g/mol. In the context of the present invention, the chain extender is understood to mean a compound having at least two functional groups reactive toward isocyanates, for example hydroxyl groups, amino groups or thiol groups, and a molecular weight Mw of less than 499 g/mol. At the same time, in the context of the present invention, the polyol composition is also free of compounds of this kind.

Preferably, the chain extenders have a molecular weight less than 300 g/mol, or from 10 g/mol to 210 g/mol. Another preferred chain extender has a molecular weight from 50 g/mol to 150 g/mol, or from 50 g/mol to 120 g/mol, or from 60 g/mol to 120 g/mol.

Suitable chain extenders can be selected from ethylene glycol, 1,2-propanediol, 1,3-propanediol, 1-5 pentanediol. 1,6-hexanediol, 1,10-decanediol, 1,2-dihydroxycyclohexane, 1,3-dihydroxycyclohexane, 1,4-dihydroxycyclohexane, diethylene glycol. 1,4-butanediol, bis(2-hydroxy-ethyl) hydroquinone, dipropylene glycol, glycerol. diethanolamine, and triethanolamine. Preferably, the chain extender can be selected from 1,2-ethylene glycol, 1,3-propylene glycol, 1,4 butane diol, 1,5-pentane diol, 1,6-hexane diol, Hydroquinone Bis (2-hydroxyethyl) Ether (HQEE), or/and hydroxyethylether of resorcinol or 1,3-Bis (2-hydroxyethyl) resorcinol (HER).

In one embodiment, suitable chain extenders and/or cross linkers present in the polyurethane resin composition is further described. The addition of bifunctional chain extenders, trifunctional and higher-functional cross linkers or, if appropriate, mixtures thereof might be added. Chain extenders and/or cross linkers used are preferably alkanol amines and in particular diols and/or triols having molecular weights preferably in between 60 g/mol to 300 g/mol. Suitable amounts of these chain extenders and/or cross linkers can be added and are known to the person skilled in the art. For instance, chain extenders and/or cross linkers can be present in an amount up to 99 wt.-%, or up to 20 wt.-%, based on the total weight of the polyurethane resin composition.

### Fillers:

Suitable fillers include, such as, but not limited to, silicatic minerals, examples being finely ground quartzes, phyllosilicates, such as antigorite, serpentine, homblendes, amphibols, chrysotile, and talc; metal oxides, such as kaolin, aluminum oxides, aluminium hydroxides, magnesium hydroxides, hydromagnesite. titanium oxides and iron oxides, metal salts such as chalk, heavy spar and inorganic pigments, such as cadmium sulfide, zinc sulfide, and also glass and others. Preference is given to using kaolin (china clay), finely ground quartzes, aluminum silicate, and coprecipitates of barium sulfate and aluminum silicate.

Suitable fillers have an average particle diameter in the range of 0.1 μm to 500 μm, more preferably in the range of 1 μm to 100 μm, and most preferably in the range of 1 μm to 10 μm. Diameter in this context, in the case of non-spherical particles, refers to their extent along the shortest axis in space.

Suitable amounts of the fillers can be present in the polyurethane resin composition which are known to the person skilled in the art.

### Antistatic Agents:

Antistatic additives and antistatic polymers are known. By way of example, DE 3531660 describes antistatic polyurethane shoe soles. The antistatic effect is achieved via from 0.01 to 0.3% by weight of chemically bonded sulfonate groups. The volume resistivities achieved are <10⁸ Ω/cm. The use of various quaternary ammonium salts for increasing the conductivity of polymers is described in EP 1134268. This involves modifications of commercially available antistatic agents. such as Catafor F® or Catafor PU® from Rhodia. For example. volume resistivities of about 107 Ω/cm are achieved at high concentrations.

Antistatic additives include ethylmethylimidazole ethyl sulfate. Ethylmethylimidazole ethyl sulfate can be used here alone or in a mixture, for example together with other antistatic additives. It is preferable that ethylmethylimidazole ethyl sulfate is used as sole antistatic additive.

In an embodiment, the antistatic agent is selected from Soyabean oil with C10 to C16 Carbon chains, 1-Ethyl-3-methyl imidazolium dicyanamide, alkali metal salts in solvent, phosphoric acid and triethyl ether, metallic salt and polyether.

### Stabilizers

Hydrolysis stabilizers used preferably comprise oligomeric and/or polymeric aliphatic or aromatic carbodiimides.

In order to stabilize the PU composition, with respect to aging, it is preferable that stabilizers are added to the PU composition. For the purposes of the present invention, stabilizers are additives which protect a plastic or a plastics mixture from damaging environmental effects. Examples are primary and secondary antioxidants, hindered amine light stabilizer, UV absorber, hydrolysis stabilizer, quencher, and flame retardant (FR). Examples of commercial stabilizers are given in Plastics Additive Handbook, 5th Edition, H. Zweifel, ed., Hanser Publishers, Munich, 2001 ([1]), pp. 98-136.

If the PU foam has exposure to thermos-oxidative degradation during its use, antioxidants can be added. It is preferable to use phenolic antioxidants. Examples of phenolic antioxidants are given in Plastics Additive Handbook, 5th edition, H. Zweifel, ed, Hanser Publishers. Munich, 2001. pp. 98-107 and pp. 116-121. Preference is given to those phenolic antioxidants whose molar mass is greater than 700 g/mol. An example of a phenolic antioxidant whose use is preferred is pentaerythrityl tetrakis(3-(3,5-bis(1,1-dimethylethyl)-4-hydroxyphenyl)propionate) (Irganox® 1010).

If the PU foam is exposed to UV light in the invention, this preferably also comprises a UV absorber. UV absorbers are molecules which absorb high-energy UV light and dissipate the energy. Familiar UV absorbers used industrially are, for example, members of the group of cinnamic esters, of diphenylcyanoacrylates, of the formamidines, of the benzylidenemalonates, of the diarylbutadienes, or triazines, or of the benzotriazoles. Examples of commercial UV absorbers are found in Plastics Additive Handbook, 5th edition, H. Zweifel, ed, Hanser Publishers, Munich, 2001, pp. 116-122. In one preferred embodiment, the number-average molar mass of the UV absorbers is greater than 300 g/mol, in particular greater than 390 g/mol. The UV absorbers preferably used should moreover have molar mass no greater than 5000 g/mol, particularly preferably no greater than 2000 g/mol. The benzotriazoles group is particularly suitable as UV absorber. Examples of particularly suitable benzotriazoles are Tinuvin®213. Tinuvin® 328. Tinuvin® 571. and also Tinuvin® 384, and Eversorb®82.

In a preferred embodiment, the UV absorbers have a number average molecular weight of greater than 0.3×103 g/mol, in particular greater than 0.39×103 g/mol. Furthermore, the UV absorbers which are preferably used should have a molecular weight of not greater than 5c103 g/mol, particularly preferably not greater than 2c103 g/mol.

Particularly suitable UV absorbers are the group of benzotriazoles

A UV stabilization as described above based on an antioxidant and a UV absorber is often still not sufficient to ensure good stability of the film against the damaging influence of UV rays. In this case, a hindered amine light stabilizer (HALS) can be added in addition to the antioxidant and the UV absorber to the film. HALSs are highly efficient UV stabilizers for most polymers.

HALS compounds are generally known and commercially available. Examples of commercially available HALSs may be found in Plastics Additive Handbook, 5th edition, H. Zweifel, Hanser Publishers, Munich, 2001, pp. 123-136.

As hindered amine light stabilizers, preference is given to employing hindered amine light stabilizers in which the number average molecular weight is greater than 500 g/mol. Furthermore, the molecular weight of the preferred HALS compounds should be not greater than 10 000 g/mol, particularly preferably not greater than 5000 g/mol.

Particularly preferred hindered amine light stabilizers are bis(1,2,2,6,6-pentamethylpiperidyl) sebacate (Tinuvin® 765, Ciba Spezialitatenchemie AG) and the condensation product of 1-hydrox-yethyl-2,2,6,6-tetramethyl-4-hydroxypiperidine and succinic acid (Tinuvin® 622). Particular preference is given to the condensation product of 1-hydroxyethyl-2,2,6,6-tetramethyl-4-hydrox-ypiperidine and succinic acid (Tinuvin® 622) when the titanium content of the product is <150 ppm, preferably <50 ppm, in particular <10 ppm.

Further details regarding the abovementioned auxiliaries and additives may be found in the specialist literature, for example in Plastics Additive Handbook. 5th edition, H. Zweifel, ed., Hanser Publishers, Munich, 2001.

### Mold Release Agents:

Mold release agents include release agents based on wax or silicon, mold release agents based on salts of aliphatic mono- or polycarboxylic acids having at least 25 carbon atoms, and primary mono-, di-, or polyamines having two or more carbon atoms, or amide or ester group-containing amines, which have at least one primary, secondary or tertiary amino group, release agents based on mixtures of at least two compounds from the group of amine-carboxylic acid-salts, saturated or unsaturated CeOH- and/or OH group-containing esters from mono- and/or poly carboxylic acids, and multivalent alcohols or natural and/or synthetic oils, fats or waxes, mold release agents based on ketimines, aldimines, enamines or cyclic Schiff bases.

### Friction Reducers:

The friction reducers include polyethylene and polytetrafluoroethylene (PTFE) powders. Polyethylene includes crosslinked and non-crosslinked polyethylene. The non-crosslinked polyethylene includes high density polyethylene (HDPE), high density and high molecular weight polyethylene (HDPE-HMW), high density and ultrahigh molecular weight polyethylene (HDPE-UHMW), medium density polyethylene (MDPE). low density polyethylene (LDPE), linear low-density polyethylene (LLDPE), (VLDPE) and (ULDPE). The non-crosslinked polyethylene includes an Ultra-high molecular weight polyethylene (UHMWPE) powder.

### Blowing Agent (ABA)

In an embodiment, the PU foam includes a blowing agent (ABA). The blowing agent (ABA) includes methyl formate.

In an embodiment, the reaction mixture includes a blowing agent (ABA) from 0 wt. % to 2.0 wt. %. In a preferred embodiment, the blowing agent (ABA) is from 0 to 1.5 wt. %.

### Isocyanate (ISO)

The isocyanates (ISO) can be selected from aliphatic isocyanates, aromatic isocyanates, and a combination thereof. By the term “aromatic isocyanate”, it is referred to molecules having two or more isocyanate groups attached directly and/or indirectly to the aromatic ring. Further, it is to be understood that the isocyanate includes both monomeric and polymeric forms of the aliphatic and aromatic isocyanate. By the term “polymeric”, it is referred to the polymeric grade of the aliphatic and/or aromatic isocyanate comprising, independently of each other, different oligomers, and homologues.

In another embodiment, the isocyanate (ISO) comprises an aromatic isocyanate selected from toluene diisocyanate; polymeric toluene diisocyanate, methylene diphenyl diisocyanate; polymeric methylene diphenyl diisocyanate; m-phenylene diisocyanate: 1,5-naphthalene diisocyanate; 4-chloro-1; 3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl benzene-2,4,6-triisocyanate, tolidine diisocyanate, 1,3,5-triisopropyl benzene-2,4,6-triisocyanate and mixtures thereof. In other embodiment, the aromatic isocyanate is selected from toluene diisocyanate; polymeric toluene diisocyanate, methylene diphenyl diisocyanate; polymeric methylene diphenyl diisocyanate, m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate and 1-methyl-3,5-diethylphenylene-2,4-diisocyanate. In other embodiments, the aromatic isocyanate is selected from toluene diisocyanate; polymeric toluene diisocyanate, methylene diphenyl diisocyanate; polymeric methylene diphenyl diisocyanate, m-phenylene diisocyanate and 1,5-naphthalene diisocyanate or a combination thereof. In still other embodiment, the aromatic isocyanate is selected from toluene diisocyanate; polymeric toluene diisocyanate, methylene diphenyl diisocyanate and polymeric methylene diphenyl diisocyanate or mixture thereof.

In another embodiment, the present invention is directed to the polyurethane foam, wherein the at least one isocyanate (ISO) includes a toluene diisocyanate or a methylene diphenyl diisocyanate, or combination thereof.

In another embodiment, the aromatic isocyanate selected from methylene diphenyl diisocyanate, polymeric methylene diphenyl diisocyanate or combination thereof.

In another embodiment, the methylene diphenyl diisocyanate is available in three different isomeric forms, namely 2,2′-methylene diphenyl diisocyanate (2,2′-MDI), 2,4′-methylene diphenyl diisocyanate (2,4′-MDI) and 4,4′-methylene diphenyl diisocyanate (4,4′-MDI). Methylene diphenyl diisocyanate can be classified into monomeric methylene diphenyl diisocyanate and polymeric methylene di-phenyl diisocyanate referred to as technical methylene diphenyl diisocyanate. Polymeric methylene diphenyl diisocyanate includes oligomeric species and methylene diphenyl diisocyanate isomers. Thus, polymeric methylene diphenyl diisocyanate may contain a single methylene diphenyl diisocyanate isomer or isomer mixtures of two or three methylene diphenyl diisocyanate isomers, the balance being oligomeric species. Polymeric methylene diphenyl diisocyanate tends to have isocyanate functionalities of higher than 2. The isomeric ratio as well as the amount of oligomeric species can vary in wide ranges in these products. For instance, polymeric methylene diphenyl diisocyanate may typically contain 30 wt.-% to 80 wt.-% of methylene diphenyl diisocyanate isomers, the balance being said oligomeric species. The methylene diphenyl diisocyanate isomers are often a mixture of 4,4′-methylene diphenyl diisocyanate, 2,4′-methylene diphenyl diisocyanate and very low levels of 2,2′-methylene di-phenyl diisocyanate.

In another embodiment, the isocyanate (ISO) comprises a polymeric methylene diphenyl diisocyanate. Commercially available isocyanates available under the tradename, such as, but not limited to, Lupranate® from BASF can also be used for the purpose of the present invention.

In another embodiment, the aliphatic isocyanate is selected from isophorone diisocyanate. propylene-1,2-diisocyanate, propylene-1,3-diisocyanate. butylene-1,2-diisocyanate, butylene-1,3-diisocyanate, hexamethylene-1,6-diisocyanate, 2-methylpentamethylene-1,5-diisocyanate, 2-ethylbutylene-1,4-diisocyanate, 1,5-pentamethylene diisocyanate, ethyl ester 1-lysine triisocyanate, 1,6,11-triisocyanatoundecane, (2,4,6-trioxotriazine-1,3,5(2h,4h,6h)-triyl)tris(hexamethylene) isocyanate, methyl-2,6-diisocyanate caproate, octamethlyene-1,8-diisocyanate, 2,4,4-trimethylhexamethylene-1,6-diisocyanate, nonamethylene diisocyanate, 2,2,4-trimethylhexamethylene-1,6-diisocyanate, decamethylene-1,10-diisocyanate, 2,11-diisocyanato-dodecane, triphe-nylmethane-4,4′,4″-triisocyanate, toluene-2,4,6-triyl triisocyanate, tris(isocyanatohexyl)biuret, trimethyl-cyclohexyl] triisocyanate. 2,4,4′-triisocyanato-dicyclohexylmethane, 2,2,-methylene-bis(cyclohexyl isocyanate), 3,3′-methylene-bis(cyclohexyl isocyanate), 4,4′-methylene-bis(cyclohexyl isocyanate), 4,4′-ethylene-bis(cyclohexyl isocyanate), 4,4′-propylene-bis-(cyclohexyl isocyanate), bis(paraisocyano-cyclohexyl)sulfide, bis(para-isocyanato-cyclohexyl)sulfone, bis(para-isocyano-cyclohexyl)ether, bis(para-isocyanato-cyclohexyl)diethyl silane, bis(para-isocyanato-cyclohexyl)diphenyl silane, bis(para-isocyanato-cyclohexyl)ethyl phosphine oxide, bis(para-isocyanato-cyclohexyl)phenyl phosphine oxide, bis(para-isocyanato-cyclohexyl)N-phenyl amine. bis(para-isocyanato-cyclohexyl)N-methyl amine, 3,3-diisocyanato adamantane, 3,3-diisocyano biadamantane, 3,3-diiso-cyanatoethyl-1′-biadamantane, 1,2-bis(3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclo-hexane, 1,2-diisocyanato octadecane, 2,5-diisocyanato-1,3,4-oxadiazole, OCN(CH2)3O(CH2)2O(CH2)3NCO and OCN(CH2)3N(CH3)(CH2)3NCO or polymeric forms of diisocyanates.; more preferably the aliphatic isocyanate selected from isophorone diisocyanate, propylene-1,2-diisocyanate, propylene-1,3-diisocyanate, butylene-1,2-diisocyanate. butylene-1,3-diisocyanate. hexamethylene-1,6-diisocyanate, 2-methylpentamethylene-1,5-diisocyanate1,5-pentamethylene diisocyanate, 1,6,11-triisocyanatoundecane, methyl-2,6-diisocyanate caproate, octamethlyene-1,8-diisocyanate, 2,4,4-trimethylhexamethylene-1,6-diisocyanate, nonamethylene diisocyanate, 2,2,4-trimethylhexamethylene-1,6-diisocyanate. decamethylene-1,10-diisocyanate, 2,11-diisocyanato-dodecane or polymeric forms of diisocyanates; and most preferably the aliphatic isocyanate selected from isophorone diisocyanate, hexamethylene-1,6-diisocyanate, 2-methylpentamethylene-1,5-diisocyanate, 1,5-pentamethylene diisocyanate, 1octamethlyene-1,8-diisocyanate, 2,4,4-trimethylhexamethylene-1,6-diisocyanate, nonamethylene diisocyanate, 2,2,4-trimethylhexamethylene-1,6-diisocyanate. decamethylene-1,10-diisocyanate, 2,11-diisocyanato-dodecane and polymeric forms of diisocyanates or mixtures thereof.

In an embodiment, the reaction mixture has the isocyanate (ISO) is in an amount from 1 wt.-% to 60 wt.-%. In a preferred embodiment, the isocyanate component of the isocyanate is from 1 w t.-% to 55 wt.-%, or from 5 wt.-% to 55 wt.-%, or from 10 wt.-% to 55 wt.-%, or from 15 wt.-% to 55 wt.-%. More preferably, the isocyanate is from 20 wt.-% to 55 wt.-%, or from 23 wt.-% to 55 wt.-%, or from 25 wt.-% to 55 wt.-%.

In an embodiment, the reaction mixture has the isocyanate (ISO) is in an amount from 25 wt.-% to 50 wt.-%, or from 25 wt.-% to 45 wt.-%, or from 25 wt.-% to 40 wt.-%.

In an embodiment, the at least one isocyanate (ISO) includes a toluene diisocyanate or a methylene diphenyl diisocyanate, or combination thereof.

In another embodiment, the PU foam comprises at least two isocyanates (ISO), the first isocyanate (ISO1) and the second isocyanate (ISO2). The first isocyanate (ISO1) and the second isocyanate (ISO2) are two different isocyanates as described herein. The first isocyanate (ISO1) and the second isocyanate (ISO2) each independent of each other has an isocyanate functionality of at least 2.0, said second isocyanate (ISO2) being different than the first isocyanate (ISO1).

### Process of Forming the Polyurethane Foam

In another aspect, the present invention is directed to a process of forming the polyurethane foam, the process comprising the steps:
a. mixing components of the reaction mixture;
b. optionally heating the reaction mixture;
c. optionally curing the polyurethane foam.

In an embodiment, the reaction mixture is as described hereinabove. The reaction mixture comprises components:
a. at least one isocyanate;
b. a polyol composition having at least one EO/PO copolymer (P1) with components ethylene oxide (EO), propylene oxide (PO), and glycerine:
c. at least one additive; and
d. optionally, at least one chain extender;

The components of the reaction mixture are mixed to form the polyurethane foam.

In an embodiment, the mixing is done in a mixer. In a preferred embodiment, high-speed mixer is used.

In an embodiment, reaction mixture is heated after mixing to form the polyurethane foam. In a preferred embodiment, the present invention is directed to process, wherein the heating is performed at a temperature in range from 50° C. to 250° C.

In an embodiment, the polyurethane foam is cured.

In an embodiment, the components of the reaction mixture are mixed using a Cannon-Viking Slab Foam Machine. The components are metered into a mixing head chamber via pumps where they are then mixed through high shear force. The reaction mixture in liquid form is then poured onto a moving conveyer where the reaction takes place. As the reaction occurs, foam buns are made.

### An Article Prepared by the Polyurethane Foam

In another aspect, the present invention is directed to an article prepared by the polyurethane foam described herein, or by the process of forming the polyurethane foam as described herein. The article includes bedding, upholstery, cushion, mattress, automotive components and other components that need cushioning and padding.

### Use of the Polyurethane Foam

In another aspect, the present invention is directed to use of the polyurethane foam as described herein or formed by the process of forming the polyurethane foam as described herein, or an article having the polyurethane foam.

The PU Foam is used for automotive and bedding industry, which include upholstered furniture as well as technical articles. Use also includes application in full foam seats. dashboards, and restraints for back and head are all made from flexible polyurethane foam. Other applications of the polyurethane foam include carpet backings, bedding and mattresses, gaskets between a car body and its lights, lip seals of air filters for engines and insulating layers on car parts and engine parts to reduce sound and vibration.

Method of Preparing Artilce with PU Foam

In another aspect, the present invention is directed to a method of preparing articles for automotive, furnishing, bedding industry comprising at least the step of providing a polyurethane foam as described herein.

### Advantages of the PU Foam

The at least one EO/PO copolymer (P1) is associated with below advantages:
a. is more reactive than current offerings for slab foam application,
b. allows for the reduction of amine catalyst (Am), tin catalyst (Cat A), and surfactant in the urethane reaction,
c. increase in usage of tin catalyst (Cat A) is associated with improvement of the physical properties of the polyurethane.
d. results in cost savings for foam manufacturers, and
e. usage requires lower amine catalyst (Am) level means less VOC in the PU foams.

The presently claimed invention is illustrated in more detail by the following embodiments and combinations of embodiments which results from the corresponding dependency references and links:
I. A polyurethane (PU) foam prepared from a reaction mixture comprising components:
   a. at least one isocyanate:
   b. a polyol composition having at least one EO/PO copolymer (P1) with components ethylene oxide (EO), propylene oxide (PO), and glycerine;
   c. at least one additive; and
   d. optionally, at least one chain extender;
   wherein the at least one EO/PO copolymer (P1) includes
   i. component of ethylene oxide (EO) from 8.0 wt. % to 40.0 wt. %,
   ii. component of propylene oxide (PO) from 59.0 wt. % to 91.0 wt. %, and
   iii. component of glycerine from 0.1 wt. % to 5.0 wt. % of the at least one EO/PO copolymer (P1);
   wherein the at least one EO/PO copolymer (P1) optionally includes a propylene oxide (PO) capping.
II. The polyurethane foam of embodiment IL. wherein the at least one EO/PO copolymer (P1) includes
   i. component of ethylene oxide (EO) from 12.0 wt. % to 30.0 wt. % of the at least one EO/PO copolymer (P1);
   ii. component of propylene oxide (PO) from 65.0 wt. % to 87.0 wt. % of the at least one EO/PO copolymer (P1);
   iii. component of glycerine from 1.0 wt. % to 5.0 wt. % of the at least one EO/PO copolymer (P1).
III. The polyurethane foam of embodiment I or II, wherein the at least one EO/PO copolymer (P1) includes
   i. component of ethylene oxide (EO) from 12.0 wt. % to 30.0 wt. % of the at least one EO/PO copolymer (P1);
   ii. component of propylene oxide (PO) from 66.0 wt. % to 86.0 wt. % of the at least one EO/PO copolymer (P1);
   iii. component of glycerine from 2.0 wt. % to 4.0 wt. % of the at least one EO/PO copolymer (P1)
IV. The polyurethane foam of any one of embodiment I to III, wherein the polyol composition includes at least one second polyol (P2) selected from polyether polyols, polyester polyols, polyetherester polyols, polytetrahydrofuran, polyester diol, or a combination thereof.
V. The polyurethane foam of any one of embodiments I to IV, wherein the at least at least one second polyol (P2) is a polyether polyol, preferably a polyether triol.
VI. The polyurethane foam of any one of embodiments I to V, wherein the at least at least one second polyol (P2) has a molecular weight in range from 2500 g/mol to 4500 g/mol.
VII. The polyurethane foam of any one of embodiments I to VI, wherein the at least at least one second polyol (P2) has a hydroxyl number in range from 50 mg KOH/g to 60 mg KOH/g calculated by ASTM D4274-21.
VIII. The polyurethane foam of any one of embodiment I to VII, wherein the polyol composition includes at least two polyols.
IX. The polyurethane foam of any one of embodiment I to VIII, wherein the at least one isocyanate includes a toluene diisocyanate or a methylene diphenyl diisocyanate. or combination thereof.
X. The polyurethane foam of any one of embodiment I to XI, wherein the at least one additive includes a silicon, a catalyst, an amine, a flame retardant (FR), a blowing agent (ABA), water, an antioxidant, a mold release agent, a lubricant, a plasticiser. a hydrolysis stabilizer, an anti-blocking agent, a light stabilizer, a cross linker, a catalyst, a rheology additive, a defoamer, a friction reducer, an antistatic agent, a surfactant, and other components, or combination thereof.
XI. The polyurethane foam of any one of embodiments I to X. wherein the starter selected from TMP, ethylene glycol, diethylene glycol, castor oil, and other bio renewable starter molecule
XII. The polyurethane foam of any one of embodiment I to XII, wherein the catalyst selected from tin catalyst (Cat A), an amine catalyst (Am). zinc cobalt catalyst, or combination thereof.
XIII. A process of forming the polyurethane foam of any one of the preceding embodiments I to XII, the process comprising the steps:
   a. mixing components of the reaction mixture;
   b. optionally heating the reaction mixture:
   c. optionally curing the polyurethane foam.
XIV. The process of embodiment XIII. wherein the heating is performed at a temperature in range from 50° C. to 250° C.
XV. An article prepared by the polyurethane foam of any one of the preceding embodiments 1 to 12 or by the process of any of the preceding embodiments XIII and XIV.
XVI. Use of the polyurethane foam of any one of the preceding embodiments I to XII or by the process of any of the preceding embodiments XIII and XIV or the article prepared by the polyurethane foam, in embodiment XV.
XVII. A polyol composition used in the polyurethane foam of any one of above embodiment, wherein the polyol composition includes at least one EO/PO copolymer (P1) comprising:
   a. an ethylene oxide (EO) component from 8.0 wt. % to 40.0 wt. % of the at least one EO/PO copolymer (P1);
   b. a propylene oxide (PO) component from 59.0 wt. % to 91.0 wt. % of the at least one EO/PO copolymer (P1), and
   c. a glycerine component from 0.1 wt. % to 5.0 wt. % of the at least one EO/PO copolymer (P1).
XVIII. A method of preparing articles for automotive, furnishing, bedding industry comprising at least the step of providing a polyurethane foam according any one of the embodiments I to XVI.

The presently claimed invention is illustrated by the non-restrictive examples which are as follows:

### Raw Materials

| | |
|---|---|
| Pol 1 | Inventive Polyol, Hydroxyl Number 53 mg KOH/g |
| Pol B | Polyol/Polyether triol, Molecular Weight |
| | 3000 g/mol, Total Acid Number <= 0.010, |
| | Hydroxyl Number 54.5-57.5 mg KOH/g STI |
| | 3007/3162, PBW Added |
| Water | |
| FR | Alkyl-pendant organosilicone |
| Am 1 | Non-emissive amine catalyst 1 |
| Am 2 | Non-emissive amine catalyst 2 |
| Cat A | Stannous Octoate, Tin catalyst |
| ABA | Methyl Formate, blowing agent |
| ISO | TDI, 80%-20% mixture of the 2,4 and |
| | 2,6 isomers of toluene diisocyanate, NCO |
| | content, wt. % 48.2, Molecular weight 174.2, |
| | Index 110 |

### Standard Methods:

| | |
|---|---|
| ASTM D790 | Flexural Modulus, psi (MPa) |
| ASTM D790 | Flexural Stress, peak, psi (MPa) |
| ASTM D790 | Flexural Strain, peak, % |
| ASTM D638 | Tensile Modulus, psi (MPa) |
| ASTM D638 | Tensile Stress, peak, psi (MPa) |
| ASTM D638 | Tensile Strain at Break, % |
| ASTM D256 | Notched Izod Impact Strength, ft-lb/in (J/m) |
| ASTM D792 | Molded density (Specific gravity) |
| ASTM D648 | Heat Deflection Temperature @ 66 psi, ° C. |
| ASTM D2240 | Hardness Shore D |
| ASTM D4274-21 | OH value |

### Forming Polyol 1

Polyol 1 was prepared using EO, PO and Glycerine. 4 Polyol1 were prepared with change in % of EO varying from 12%, 17%, 21% and 26%.

Glycerine was charged to a reactor purged with nitrogen. The reactor was heated and stripped under vacuum. The reactor was further charged with a mixture of ethylene oxide (EO) and propylene oxide (PO). The mixture was then reacted.

### Forming Polyurethane Foam (PU Foam)

Table provide PBW of the components of the PU Foam. Examples have TDI as isocyanate component. Examples have TDI index of 115 or 110.

Inventive examples (E) with Pol 1 are prepared along with comparative Examples (CE) with Pol 2. For closer comparison, Examples are clustered in 4 Sets based on % of EO in Inventive Examples (E)along with closest comparative Examples (CEs):
a. SET 1 for (E) having Polyol with 12% EO and corresponding (CE)
b. SET 2 for (E) having Polyol with 17% EO and corresponding (CE)
c. SET 3 for (E) having Polyol with 21% EO and corresponding (CE)
d. SET 4 for (E) having Polyol with 26% EO and corresponding (CE)

Target grade of Examples 1-14, 21 to 26, 33-46 is 1.8; for Ex 7-8 is 2.5, for Ex 15-19, 27-32 is 1.25.

Components were at temperature from 20° C. to 25° C. Components of the PU Foam were mixed in a high-speed mixer at 2000 RPM with N2 gas passed at flow rate of 1 L/m.

PU FOAM were made using a Cannon-Viking Slab Foam Machine. Each of the components in the formulation table was metered into a mixing head chamber via pumps where they were then mixed through high shear force. The reaction mixture in liquid form was then poured onto a moving conveyer where the reaction takes place. As the reaction occurs, foam buns are made measuring 42″ in height by 50″ in width by up 60 feet in length. The foam buns are allowed to cool and then cut. The cut sections are then sent to testing.

TABLE 1
COMPOSITION OF PU IN EXAMPLES 1 TO 45.

| | | | | | | | | | | | |
|---|---|---|---|---|---|---|---|---|---|---|---|
| Sr No. | % EO | Pol 1 | Pol B | Water | FR | Am 1 | Am 2 | Cat A | ABA | Iso | Total PBW |

SET 1 for Inventive Examples having Polyol with 12% EO

| | | | | | | | | | | | |
|---|---|---|---|---|---|---|---|---|---|---|---|
| CE1 | | | 100 | 2.90 | 1.0 | 0.16 | 0.08 | 0.20 | 2 | 40.47 | 146.8 |
| CE2 | | | 100 | 2.90 | 1.0 | 0.16 | 0.08 | 0.15 | 2 | 40.47 | 146.8 |
| E3 | 12 | 100 | | 2.90 | 1.0 | 0.16 | 0.08 | 0.20 | 2 | 39.96 | 146.3 |
| E4 | 12 | 100 | | 2.90 | 1.0 | 0.16 | 0.08 | 0.15 | 2 | 39.96 | 146.2 |
| CE5 | | | 100 | 2.90 | 1.0 | 0.16 | 0.08 | 0.25 | 2 | 40.47 | 146.9 |
| CE6 | | | 100 | 2.90 | 1.0 | 0.16 | 0.08 | 0.22 | 2 | 40.47 | 146.8 |
| CE7 | 12 | 100 | | 2.90 | 1.0 | 0.16 | 0.08 | 0.25 | 2 | 39.96 | 146.3 |
| CE8 | 12 | 100 | | 2.90 | 1.0 | 0.16 | 0.08 | 0.22 | 2 | 39.96 | 146.3 |

SET 2 for Inventive Examples having Polyol with 17% EO

| | | | | | | | | | | | |
|---|---|---|---|---|---|---|---|---|---|---|---|
| CE9 | | | 100 | 2.90 | 1.0 | 0.16 | 0.08 | 0.25 | 2 | 40.47 | 146.9 |
| CE10 | | | 100 | 2.90 | 1.0 | 0.16 | 0.08 | 0.20 | 2 | 40.47 | 146.8 |
| CE11 | | | 100 | 2.90 | 1.0 | 0.16 | 0.08 | 0.15 | 2 | 40.47 | 146.8 |
| E12 | 17 | 100 | | 2.90 | 1.0 | 0.16 | 0.08 | 0.25 | 2 | 40.30 | 146.7 |
| E13 | 17 | 100 | | 2.90 | 1.0 | 0.16 | 0.08 | 0.20 | 2 | 40.30 | 146.6 |
| E14 | 17 | 100 | | 2.90 | 1.0 | 0.16 | 0.08 | 0.15 | 2 | 40.30 | 146.6 |
| CE15 * | | | 100 | 4.50 | 1.0 | 0.12 | 0.08 | 0.25 | | 60.08 | 166.0 |
| CE16 * | | | 100 | 4.50 | 1.0 | 0.12 | 0.08 | 0.20 | | 60.08 | 166.0 |
| CE17 * | | | 100 | 4.50 | 1.0 | 0.12 | 0.08 | 0.15 | | 60.08 | 165.9 |
| E18 * | 17 | 100 | | 4.50 | 1.0 | 0.12 | 0.08 | 0.25 | | 59.91 | 165.9 |
| E19 * | 17 | 100 | | 4.50 | 1.0 | 0.12 | 0.08 | 0.20 | | 59.91 | 165.8 |

SET 3 for Inventive Examples having Polyol with 21% EO

| | | | | | | | | | | | |
|---|---|---|---|---|---|---|---|---|---|---|---|
| CE21 | | | 100 | 2.90 | 1.0 | 0.16 | 0.08 | 0.25 | 2 | 40.47 | 146.9 |
| CE22 | | | 100 | 2.90 | 1.0 | 0.16 | 0.08 | 0.20 | 2 | 40.47 | 146.8 |
| CE23 | | | 100 | 2.90 | 1.0 | 0.16 | 0.08 | 0.15 | 2 | 40.47 | 146.8 |
| E24 | 21 | 100 | | 2.90 | 1.0 | 0.16 | 0.08 | 0.25 | 2 | 40.30 | 146.7 |
| E25 | 21 | 100 | | 2.90 | 1.0 | 0.16 | 0.08 | 0.20 | 2 | 40.30 | 146.6 |
| E26 | 21 | 100 | | 2.90 | 1.0 | 0.16 | 0.08 | 0.15 | 2 | 40.30 | 146.6 |
| CE27 * | | | 100 | 4.50 | 1.0 | 0.12 | 0.08 | 0.25 | | 60.08 | 166.0 |
| CE28 * | | | 100 | 4.50 | 1.0 | 0.12 | 0.08 | 0.20 | | 60.08 | 166.0 |
| CE29 * | | | 100 | 4.50 | 1.0 | 0.12 | 0.08 | 0.15 | | 60.08 | 165.9 |
| E30 * | 21 | 100 | | 4.50 | 1.0 | 0.12 | 0.08 | 0.25 | | 59.91 | 165.9 |
| E31 * | 21 | 100 | | 4.50 | 1.0 | 0.12 | 0.08 | 0.20 | | 59.91 | 165.8 |
| E32 * | 21 | 100 | | 4.50 | 1.0 | 0.12 | 0.08 | 0.15 | | 59.91 | 165.8 |

SET 4 for Inventive Examples having Polyol with 26% EO

| | | | | | | | | | | | |
|---|---|---|---|---|---|---|---|---|---|---|---|
| CE33 | | | 100 | 2.90 | 1.0 | 0.16 | 0.08 | 0.25 | 2 | 40.47 | 146.9 |
| CE34 | | | 100 | 2.90 | 1.0 | 0.16 | 0.08 | 0.20 | 2 | 40.47 | 146.8 |
| CE35 | | | 100 | 2.90 | 1.0 | 0.16 | 0.08 | 0.15 | 2 | 40.47 | 146.8 |
| E36 | 26 | 100 | | 2.90 | 1.0 | 0.16 | 0.08 | 0.25 | 2 | 40.30 | 146.7 |
| E37 | 26 | 100 | | 2.90 | 1.0 | 0.16 | 0.08 | 0.20 | 2 | 40.30 | 146.6 |
| E38 | 26 | 100 | | 2.90 | 1.0 | 0.16 | 0.08 | 0.15 | 2 | 40.30 | 146.6 |
| E39 | 26 | 100 | | 2.90 | 1.0 | 0.16 | 0.08 | 0.15 | 2 | 40.30 | 146.6 |
| E40 | 26 | 100 | | 2.90 | 0.8 | 0.16 | 0.08 | 0.15 | 2 | 40.30 | 146.4 |
| E41 | 26 | 100 | | 2.90 | 0.8 | 0.13 | 0.06 | 0.15 | 2 | 40.29 | 146.3 |
| E42 | 26 | 100 | | 2.90 | 0.8 | 0.13 | 0.06 | 0.12 | 2 | 40.29 | 146.3 |
| E43 | 26 | 100 | | 2.90 | 0.8 | 0.13 | 0.06 | 0.12 | 2 | 40.29 | 146.3 |
| E44 | 26 | 100 | | 2.90 | 0.8 | 0.13 | 0.06 | 0.10 | 2 | 40.29 | 146.3 |
| E45 | 26 | 100 | | 2.90 | 0.7 | 0.13 | 0.06 | 0.10 | 2 | 40.29 | 146.2 |

* Marked Examples have TDI index of 115, rest all Examples have TDI Index of 110.

### Testing of PU Foam

The PU Foam were tested based on the standard methods to determine the Density (pcf), Tensile (psi), Elongation %, High Temperature Air/Steam Gasification (i.e. HTAG) Tensile strength (psi), HTAG Elongation, % Tear (pi), Resilience %. Indentation Force Deflection (IFD) lb./50 sq. in. (4 in.) for 25% and 65%, 25% Return, Support Factor Recovery (%), Compression Sets % (set 50%) and (set 90%), 50%** 90%**, CFD % of Original 50%, Air Flow (cfm), Height (% Loss), Static Fatigue (referred to as #SF in Tables) (Height, % Loss, IFD, 25% Loss, IFD, 65% Loss) and Pounding (referred to as #P in Tables) (80k cycles) (Height, % Loss, 40% IFD. % Loss).

The test results are provided in Tables 2 to 5. Tables 2 to 5 provide test results for the Examples 1 to 45.

It is evident from Tables 2 to 5 that the PU Foam based on the inventive polyol and standard polyol display similar properties

TABLE 2
Properties of Examples 1 to 23 (Part A)

| | Den- | Ten- | | HTAG | HTAG | | | | | | | Re- |
|---|---|---|---|---|---|---|---|---|---|---|---|---|
| Sr | sity, | sile, | Elgn, | Ten- | Elgn, | Tear, | Resi, | IFD | IFD | 25% | Support | covery, |
| No. | pcf | psi | % | sile, psi | % | pi | % | 25% | 65% | Return | Factor | % |
| E1 | 1.84 | 13.0 | 110 | 16.8 | 199 | 2.0 | 55 | 29.7 | 71.5 | 24.2 | 2.41 | 81 |
| E2 | 2.36 | 10.6 | 61 | 12.1 | 88 | 1.0 | 56 | 31.3 | 92.8 | 25.4 | 2.92 | 81 |
| E3 | 1.70 | 11.2 | 132 | 13.2 | 218 | 2.2 | 53 | 28.6 | 64.7 | 22.8 | 2.27 | 80 |
| E4 | 2.17 | 9.7 | 79 | 11.6 | 118 | 0.8 | 56 | 27.9 | 82.7 | 22.4 | 2.94 | 80 |
| E5 | 1.64 | 13.4 | 153 | 15.0 | 243 | 2.3 | 49 | 29.8 | 63.0 | 23.4 | 2.12 | 79 |
| E6 | 1.64 | 12.0 | 163 | 13.3 | 243 | 2.4 | 50 | 28.7 | 61.1 | 22.5 | 2.13 | 79 |
| E7 | 1.67 | 12.9 | 167 | 14.7 | 254 | 2.7 | 52 | 28.9 | 63.8 | 22.8 | 2.21 | 79 |
| E8 | 1.62 | 11.6 | 156 | 13.8 | 247 | 2.4 | 51 | 27.1 | 59.0 | 21.5 | 2.17 | 79 |
| E9 | 1.64 | 13.0 | 148 | 13.3 | 219 | 2.2 | 47 | 32.1 | 66.7 | 24.8 | 2.08 | 77 |
| E10 | 1.72 | 12.6 | 120 | 14.3 | 203 | 2.1 | 54 | 30.0 | 66.7 | 24.2 | 2.22 | 81 |
| E11 | 1.64 | 13.0 | 130 | 14.0 | 179 | 2.1 | 58 | 26.3 | 59.7 | 21.4 | 2.28 | 82 |
| E12 | 1.60 | 14.8 | 181 | 11.5 | 223 | 2.4 | 39 | 30.7 | 63.8 | 23.2 | 2.08 | 76 |
| E13 | 1.64 | 13.8 | 146 | 13.4 | 220 | 2.4 | 48 | 30.2 | 64.9 | 23.9 | 2.15 | 79 |
| E14 | 1.63 | 10.8 | 147 | 12.1 | 236 | 2.2 | 47 | 29.1 | 62.9 | 23.4 | 2.16 | 80 |
| E15 | 1.24 | 14.9 | 112 | 18.3 | 186 | 1.9 | 39 | 45.1 | 96.4 | 29.3 | 2.14 | 65 |
| E16 | 1.29 | 16.5 | 100 | 21.1 | 176 | 2.0 | 45 | 43.3 | 95.1 | 29.6 | 2.20 | 68 |
| E17 | 1.38 | 13.4 | 111 | 17.3 | 162 | 1.9 | 44 | 39.7 | 90.3 | 28.0 | 2.28 | 71 |
| E18 | 1.23 | 13.6 | 113 | 17.8 | 197 | 1.8 | 33 | 46.3 | 99.7 | 30.0 | 2.16 | 65 |
| E19 | 1.29 | 13.8 | 99 | 18.0 | 175 | 1.9 | 44 | 43.1 | 97.6 | 29.0 | 2.27 | 67 |
| E21 | 1.63 | 14.0 | 185 | 13.0 | 248 | 2.5 | 49 | 29.8 | 63.9 | 23.5 | 2.14 | 79 |
| E22 | 1.63 | 13.9 | 149 | 14.7 | 224 | 2.2 | 55 | 28.5 | 62.0 | 22.7 | 2.17 | 80 |
| E23 | 1.67 | 12.8 | 157 | 13.5 | 218 | 2.2 | 56 | 26.8 | 60.1 | 21.6 | 2.25 | 81 |

TABLE 3
Properties of Examples 24 to 45 (Part A)

| | Den- | Ten- | | HTAG | HTAG | | | | | | | Re- |
|---|---|---|---|---|---|---|---|---|---|---|---|---|
| Sr | sity, | sile, | Elgn, | Tensile, | Elgn, | Tear, | Resi, | IFD | IFD | 25% | Support | covery, |
| No. | pcf | psi | % | psi | % | pi | % | 25% | 65% | Return | Factor | % |
| E24 | 1.50 | 12.8 | 223 | 10.6 | 277 | 2.6 | 40 | 27.1 | 56.8 | 19.2 | 2.10 | 71 |
| E25 | 1.61 | 13.4 | 202 | 12.7 | 285 | 2.7 | 35 | 29.4 | 61.9 | 21.8 | 2.11 | 74 |
| E26 | 1.63 | 12.0 | 179 | 11.8 | 255 | 2.5 | 48 | 28.0 | 60.2 | 21.8 | 2.15 | 78 |
| E27 | 1.28 | 14.0 | 110 | 17.2 | 173 | 2.0 | 43 | 42.5 | 94.4 | 28.3 | 2.22 | 66 |
| E28 | 1.42 | 15.2 | 91 | 21.7 | 175 | 2.6 | 44 | 44.5 | 101.5 | 30.5 | 2.27 | 68 |
| E29 | 1.34 | 16.3 | 118 | 19.2 | 165 | 2.2 | 49 | 35.9 | 82.2 | 25.2 | 2.29 | 70 |
| E30 | 1.17 | 14.4 | 127 | 15.9 | 184 | 2.1 | 22 | 42.2 | 92.7 | 26.1 | 2.20 | 62 |
| E31 | 1.20 | 15.4 | 132 | 17.0 | 186 | 2.0 | 31 | 43.4 | 95.0 | 27.2 | 2.19 | 63 |
| E32 | 1.26 | 17.9 | 117 | 21.1 | 184 | 2.1 | 38 | 43.2 | 94.9 | 27.7 | 2.20 | 64 |
| E33 | 1.56 | 13.2 | 188 | 11.7 | 239 | 2.7 | 45 | 29.2 | 60.5 | 21.9 | 2.07 | 75 |
| E34 | 1.62 | 12.5 | 154 | 13.3 | 233 | 2.3 | 50 | 27.6 | 58.9 | 21.8 | 2.14 | 79 |
| E35 | 1.62 | 12.3 | 163 | 13.6 | 230 | 2.4 | 56 | 25.4 | 56.3 | 20.4 | 2.22 | 80 |
| E36 | 1.57 | 13.0 | 208 | 9.3 | 186 | 2.3 | 38 | 21.9 | 51.0 | 15.8 | 2.33 | 72 |
| E37 | 1.44 | 11.2 | 219 | 8.3 | 236 | 2.8 | 37 | 23.8 | 50.5 | 16.9 | 2.12 | 71 |
| E38 | 1.57 | 13.6 | 187 | 12.4 | 274 | 2.5 | 36 | 27.8 | 58.4 | 21.1 | 2.10 | 76 |
| E39 | 1.61 | 12.0 | 169 | 11.2 | 280 | 2.3 | 36 | 31.3 | 64.8 | 23.6 | 2.06 | 75 |
| E40 | 1.62 | 11.4 | 158 | 10.8 | 257 | 2.2 | 40 | 31.4 | 65.0 | 23.8 | 2.07 | 76 |
| E41 | 1.63 | 12.4 | 178 | 11.0 | 251 | 2.3 | 34 | 31.8 | 66.5 | 24.3 | 2.09 | 76 |
| E42 | 1.66 | 10.0 | 117 | 12.5 | 263 | 2.1 | 47 | 32.4 | 67.6 | 25.5 | 2.09 | 79 |
| E43 | 1.60 | 11.3 | 166 | 11.9 | 259 | 2.3 | 42 | 28.9 | 59.6 | 22.0 | 2.06 | 76 |
| E44 | 1.63 | 10.2 | 137 | 12.2 | 246 | 2.0 | 45 | 28.8 | 61.0 | 22.6 | 2.12 | 78 |
| E45 | 2.01 | 10.7 | 143 | 13.2 | 256 | 2.0 | 51 | 28.5 | 66.2 | 23.2 | 2.32 | 80 |

TABLE 4
Properties of Examples 1 to 23 (Part B)

| | | | | | CFD, | | | | IFD, | 40% | IFD, |
|---|---|---|---|---|---|---|---|---|---|---|---|
| | Comp | Comp | | | % Of | Air | Height, | Height, | 25% | IFD, % | 65% |
| Sr | Sets, | Sets, | | | Original | Flow, | % Loss | % Loss | Loss | Loss | Loss |
| No. | 50% | 90% | 50%** | 90%** | 50% | cfm | #SF | #P | #SF | #P | #SF |
| E1 | 2 | 5 | 8 | 11 | 71 | 2.67 | 2.7 | 2.2 | 20.1 | 25.2 | 19.1 |
| E2 | 3 | 5 | 9 | 25 | 70 | 2.54 | 3.1 | 2.7 | 22.5 | 21.6 | 20.1 |
| E3 | 2 | 4 | 5 | 9 | 71 | 3.73 | 2.3 | 2.0 | 22.3 | 26.7 | 22.3 |
| E4 | 3 | 6 | 6 | 18 | 67 | 2.37 | 2.9 | 2.5 | 22.5 | 22.8 | 20.4 |
| E5 | 1 | 4 | 5 | 13 | 72 | 10.18 | 1.4 | 1.6 | 21.3 | 29.7 | 19.7 |
| E6 | 2 | 4 | 6 | 17 | 71 | 3.57 | 1.9 | 1.8 | 22.6 | 30.5 | 19.1 |
| E7 | 2 | 5 | 6 | 20 | 71 | 2.90 | 2.0 | 1.2 | 22.4 | 21.3 | 20.2 |
| E8 | 2 | 3 | 6 | 20 | 70 | 3.87 | 1.8 | 1.0 | 21.2 | 17.8 | 21.1 |
| E9 | 3 | 5 | 7 | 12 | 69 | 2.18 | 1.7 | 1.8 | 21.6 | 29.2 | 20.1 |
| E10 | 4 | 5 | 7 | 11 | 69 | 3.05 | 2.2 | 2.2 | 21.3 | 26.8 | 19.6 |
| E11 | 3 | 4 | 7 | 9 | 70 | 4.93 | 2.2 | 2.3 | 20.8 | 24.0 | 20.4 |
| E12 | 2 | 8 | 11 | 19 | 64 | 0.74 | 1.7 | 2.0 | 23.3 | 32.9 | 22.1 |
| E13 | 3 | 5 | 6 | 9 | 67 | 1.98 | 1.8 | 1.9 | 22.3 | 28.7 | 20.6 |
| E14 | 1 | 5 | 7 | 7 | 67 | 4.57 | 1.8 | 1.7 | 22.4 | 26.0 | 21.8 |
| E15 | 3 | 8 | 8 | 21 | 78 | 1.40 | 3.4 | 3.2 | 29.7 | 35.2 | 24.7 |
| E16 | 3 | 7 | 9 | 26 | 73 | 2.33 | 3.2 | 3.3 | 27.3 | 34.5 | 23.1 |
| E17 | 3 | 7 | 8 | 36 | 73 | 3.73 | 3.4 | 3.0 | 27.1 | 34.0 | 22.2 |
| E18 | 3 | 7 | 10 | 30 | 71 | 0.62 | 4.1 | 3.8 | 28.9 | 37.1 | 24.6 |
| E19 | 4 | 10 | 13 | 47 | 73 | 1.56 | 3.9 | 4.0 | 27.7 | 36.0 | 23.8 |
| E21 | 5 | 7 | 7 | 19 | 71 | 2.29 | 1.9 | 0.9 | 21.8 | 19.8 | 20.7 |
| E22 | 4 | 7 | 7 | 22 | 72 | 3.07 | 2.0 | 0.8 | 22.1 | 21.5 | 20.2 |
| E23 | 5 | 5 | 6 | 23 | 72 | 4.73 | 2.0 | 1.0 | 20.7 | 18.3 | 20.3 |

TABLE 5
Properties of Examples 24 to 45 (Part A)

| | | | | | CFD, | | | | IFD, | 40% | IFD, |
|---|---|---|---|---|---|---|---|---|---|---|---|
| | Comp | Comp | | | % Of | Air | Height, | Height, | 25% | IFD, % | 65% |
| Sr | Sets, | Sets, | | | Original | Flow, | % Loss | % Loss | Loss | Loss | Loss |
| No. | 50% | 90% | 50%** | 90%** | 50% | cfm | #SF | #P | #SF | #P | #SF |
| E24 | 4 | 10 | 7 | 33 | 68 | 0.12 | 2.2 | 2.5 | 25.9 | 36.9 | 25.2 |
| E25 | 8 | 9 | 13 | 34 | 68 | 0.55 | 2.6 | 2.1 | 26.1 | 34.6 | 25.4 |
| E26 | 5 | 7 | 9 | 30 | 65 | 2.23 | 2.8 | 2.0 | 24.0 | 27.4 | 23.7 |
| E27 | 5 | 12 | 11 | 55 | 74 | 1.84 | 4.3 | 3.8 | 26.3 | 35.1 | 23.8 |
| E28 | 8 | 9 | 13 | 52 | 80 | 1.98 | 3.7 | 3.7 | 25.3 | 33.5 | 23.1 |
| E29 | 7 | 9 | 12 | 45 | 76 | 3.90 | 2.8 | 3.3 | 25.5 | 35.1 | 23.6 |
| E30 | 7 | 13 | 13 | 67 | 69 | 0.36 | 4.2 | 4.5 | 27.9 | 39.6 | 24.1 |
| E31 | 7 | 12 | 14 | 45 | 70 | 0.58 | 4.6 | 5.0 | 25.7 | 38.3 | 22.7 |
| E32 | 5 | 12 | 24 | 67 | 66 | 0.99 | 3.6 | 4.2 | 24.4 | 37.8 | 21.9 |
| E33 | 3 | 10 | 2 | 10 | | 1.55 | | | | | |
| E34 | 0 | 5 | 3 | 3 | | 3.53 | | | | | |
| E35 | 3 | 4 | 3 | 5 | | 4.97 | | | | | |
| E36 | 4 | 7 | 5 | 20 | | 0.20 | | | | | |
| E37 | 7 | 18 | 8 | 20 | | 0.11 | | | | | |
| E38 | 4 | 4 | 4 | 12 | | 0.53 | | | | | |
| E39 | 3 | 4 | 4 | 8 | | 0.62 | | | | | |
| E40 | 3 | 5 | 3 | 11 | | 0.91 | | | | | |
| E41 | 4 | 5 | 4 | 7 | | 0.54 | | | | | |
| E42 | 2 | 4 | 2 | 5 | | 1.79 | | | | | |
| E43 | 3 | 3 | 3 | 12 | | 1.52 | | | | | |

| | | | | | |
|---|---|---|---|---|---|
| E44 | 3 | 5 | 3 | 12 | 1.85 |
| E45 | 3 | 3 | 2 | 21 | 2.41 |

1. A polyurethane (PU) foam prepared from a reaction mixture comprising components:
a. at least one isocyanate;
b. a polyol composition having at least one EO/PO copolymer (P1) with components ethylene oxide (EO), propylene oxide (PO), and glycerine;
c. at least one additive; and
d. optionally, at least one chain extender;
wherein the at least one EO/PO copolymer (P1) includes
i. component of ethylene oxide (EO) from 8.0 wt. % to 40.0 wt. %,
ii. component of propylene oxide (PO) from 59.0 wt. % to 91.0 wt. %, and
iii. component of glycerine from 0.1 wt. % to 5.0 wt. % of the at least one EO/PO copolymer (P1);
wherein the at least one EO/PO copolymer (P1) optionally includes a propylene oxide (PO) capping.

2. The polyurethane foam of claim 1, wherein the at least one EO/PO copolymer (P1) includes
i. component of ethylene oxide (EO) from 12.0 wt. % to 30.0 wt. % of the at least one EO/PO copolymer (P1);
ii. component of propylene oxide (PO) from 65.0 wt. % to 87.0 wt. % of the at least one EO/PO copolymer (P1);
iii. component of glycerine from 1.0 wt. % to 5.0 wt. % of the at least one EO/PO copolymer (P1).

3. The polyurethane foam of claim 1, wherein the at least one EO/PO copolymer (P1) includes
i. component of ethylene oxide (EO) from 12.0 wt. % to 30.0 wt. % of the at least one EO/PO copolymer (P1);
ii. component of propylene oxide (PO) from 66.0 wt. % to 86.0 wt. % of the at least one EO/PO copolymer (P1);
iii. component of glycerine from 2.0 wt. % to 4.0 wt. % of the at least one EO/PO copolymer (P1).

4. The polyurethane foam of claim 1, wherein the polyol composition includes at least one second polyol (P2) selected from polyether polyols, polyester polyols, polyetherester polyols, polytetrahydrofuran, polyester diol, or a combination thereof.

5. The polyurethane foam of claim 1, wherein the at least at least one second polyol (P2) is a polyether polyol, preferably a polyether triol.

6. The polyurethane foam of claim 1, wherein the at least at least one second polyol (P2) has a molecular weight in range from 2500 g/mol to 4500 g/mol.

7. The polyurethane foam of claim 1, wherein the at least at least one second polyol (P2) has a hydroxyl number in range from 50 mg KOH/g to 60 mg KOH/g calculated by ASTM D4274-21.

8. The polyurethane foam of claim 1, wherein the polyol composition includes at least two polyols.

9. The polyurethane foam of claim 1, wherein the at least one isocyanate includes a toluene diisocyanate or a methylene diphenyl diisocyanate, or combination thereof.

10. The polyurethane foam of claim 1, wherein the at least one additive includes a starter, a silicon, a catalyst, an amine, a flame retardant (FR), a blowing agent (ABA), water, an antioxidant, a mold release agent, a lubricant, a plasticiser, a hydrolysis stabilizer, an anti-blocking agent, a light stabilizer, a cross linker, a catalyst, a rheology additive, a defoamer, a friction reducer, an antistatic agent, a surfactant, and other components, or combination thereof.

11. The polyurethane foam of claim 1, wherein the starter selected from TMP, ethylene glycol, diethylene glycol, castor oil, and other bio renewable starter molecule.

12. The polyurethane foam of claim 1, wherein the catalyst selected from tin catalyst (Cat A), an amine catalyst (Am), zinc cobalt catalyst, or combination thereof.

13. A process of forming the polyurethane foam of claim 1, the process comprising the steps:
a. mixing components of the reaction mixture as claimed in any one of above claims;
b. optionally heating the reaction mixture;
c. optionally curing the polyurethane foam.

14. The process as claimed in claim 13, wherein the heating is performed at a temperature in range from 50° C. to 250° C.

15. An article prepared with the polyurethane foam of claim 1.

16. (canceled)

17. A polyol composition used in the polyurethane foam of claim 1, wherein the polyol composition includes at least one EO/PO copolymer (P1) comprising:
a. component of ethylene oxide (EO) from 8.0 wt. % to 40.0 wt. %,
b. component of propylene oxide (PO) from 59.0 wt. % to 91.0 wt. %, and
c. component of glycerine from 0.1 wt. % to 5.0 wt. % of the at least one EO/PO copolymer (P1);
wherein the at least one EO/PO copolymer (P1) optionally includes a propylene oxide (PO) capping.

18. A method of preparing articles for automotive, furnishing, or bedding industry comprising at least the step of providing a polyurethane foam according to claim 1.

19. An article prepared by the process of claim 13.
